(19) United States
(12) Patent Application Publication
(10) Pub. No.: US 2004/0118764 A1
(43) Pub. Date: Jun. 24, 2004

(54) Multiple fuel filter pump module

(76) Inventors: Terry L. Miller, Morton, IL (US); Brett M. Bailey, Peoria, IL (US); Jeffrey L. Castleman, Normal, IL (US); Eric S. Keyster, Ashland City, TN (US)

Correspondence Address: Michael B. McNeil, Liell & McNeil Attorneys PC, P.O. Box 2417, Bloomington, IN, 47402, US

(21) Appl. No.: 10/327,634

(22) Filed: Dec. 20, 2002

(51) Int. Cl. B01D 35/26; B01D 36/02

(52) U.S. Cl. 210/258; 210/259; 210/416.4

(57) ABSTRACT

Often in diesel engines, there are two or more fuel filters that provide intense filtration of the fuel prior to injection of the fuel into the engine. However, the two or more fuel filters consume a considerable amount of space within the vehicle which may prevent all of the fuel filters from being attached to the engine. The present invention is a multiple fuel filter pump module that includes a module housing. The module housing is formed to include a pump housing and a dual fuel filter head portion. A fuel pump is positioned within the pump housing, and more than one detachable fuel filter assemblies are attached to the multiple fuel filter head portion. The module housing can be attached to an engine housing.

### TECHNICAL FIELD

The present invention relates generally to circulating and filtering fuel for an engine, and more specifically to a multiple fuel filter pump module.

### BACKGROUND

In several diesel engines today, fuel filters conduct intense filtering of fuel before the fuel is injected into the engine. When filtering the fuel, the fuel filters separate water and remove particulates from the fuel. Generally, a fuel pump will pump fuel from a fuel reservoir through at least one fuel filter prior to the injection of the fuel into the engine. Often, the fuel pump is included in a separate housing than the fuel filter, each housing having its own electrical connections and each housing being connected to one another via fuel supply lines.

Because separate housings for the fuel pump and the fuel filter consume valuable space within a vehicle body, fuel filters and fuel pumps have been integrated into one housing, as shown in U.S. Pat. No. 5,103,793, issued to Riese et al., on Apr. 14, 1992. By combining the fuel filter and the fuel pump within the same housing, the number of engine components is lessened, thereby, potentially reducing the space consumed by the fuel filter and fuel pump.

Over the years, engineers have found that it is advantageous, and sometimes necessary, to include two fuel filters in fuel systems. Engineers have found that two fuel filters can more intensely filter the fuel, resulting in cleaner fuel for more demanding fuel injection systems. Thus, many diesel fuel systems include a primary fuel filter that separates water and larger particulates from the fuel, and at least one secondary fuel filter that separates finer particulates from the fuel. Generally, the primary fuel filter is positioned upstream from the fuel pump in order to remove larger particulates from the fuel prior to the fuel passing through the fuel pump. This reduces the risk of the particulates damaging the fuel pump. The secondary fuel filters are positioned downstream from the fuel pump in order to filtrate the finer particulates not removed by the primary fuel filter and any particulates that may have came from the fuel pump. Because the larger particulates have already been removed from the fuel, the life of the secondary fuel filters may be prolonged.

Although it can sometimes be advantageous to include at least two fuel filters, one upstream and the other downstream from the fuel pump, such an arrangement again consumes valuable space around the engine and within the body of the vehicle. There are various methods known in the art to reduce the space consumed by the fuel filters and the fuel pump. For instance, it is known in the art to attach one of the fuel filters to the body of the vehicle and the other to the engine, or attach the primary and secondary fuel filters to the same base or within the same housing. For example, the fuel filter assembly, illustrated in U.S. Pat. No. 6,174,438 B1, issued to Hodgkins et. al, on Jan. 16, 2001, includes the primary fuel filter and the secondary fuel filter positioned in the same housing. The fuel flows from the primary fuel filter to the fuel pump via an outlet of the housing. After passing through the fuel pump, the fuel flows back into the housing and through the secondary fuel filter. Thus, the fuel makes a dual pass through the housing including both fuel filters. Although the Hodgkins fuel filter assembly strategically positions both the primary and secondary fuel filter in a compact manner, there is room for improvement.

Although the Hodgkins primary and second fuel filters are included in one housing, the fuel pump is still separate. Thus, both the fuel pump and the filters include their own connections and housings. The space the dual fuel filter housing and the pump housing consume may prohibit the attachment of the fuel filters to the engine. Rather, the fuel filters will likely be attached to the vehicle body, increasing costs of manufacturing and installing both housings. Further, by having a separate pump housing and filter housing, there is an increased potential for leaks and, thus, maintenance costs. In general, engines with less components are more robust.

The present invention is directed to overcoming one or more of the problems set forth above.

### SUMMARY OF THE INVENTION

In one aspect of the present invention, an engine includes an engine housing to which a multiple fuel filter pump module is attached. The multiple fuel filter pump module includes a module housing to which more than one detachable fuel filter assemblies are attached. A fuel pump is positioned within the module housing.

In another aspect of the present invention, a multiple fuel filter pump module includes a module housing in which a fuel pump is positioned. More than one detachable fuel filter assemblies are attached to the module housing.

In yet another aspect of the present invention, a method of manufacturing a multiple fuel filter pump module includes a step of forming a module housing to include a pump housing and a fuel filter head portion. A fuel pump is positioned within the module housing, and more than one detachable fuel filter assemblies are attached to the module housing.

### BRIEF DESCRIPTION OF THE DRAWINGS

FIG. 1 is a schematic representation of an engine and a fuel system according to the present invention;

FIG. 2 is a side view of a dual fuel filter pump module attached to the engine of FIG. 1;

FIG. 3 is a sectioned side diagrammatic view of a fuel pump included within the dual fuel filter pump module of FIG. 2;

FIG. 4 is a section side diagrammatic view of a pressure regulator included within the dual fuel filter pump module of FIG. 2; and

FIG. 5 is a sectioned side view of the dual fuel filter pump module of FIG. 2.

### DETAILED DESCRIPTION

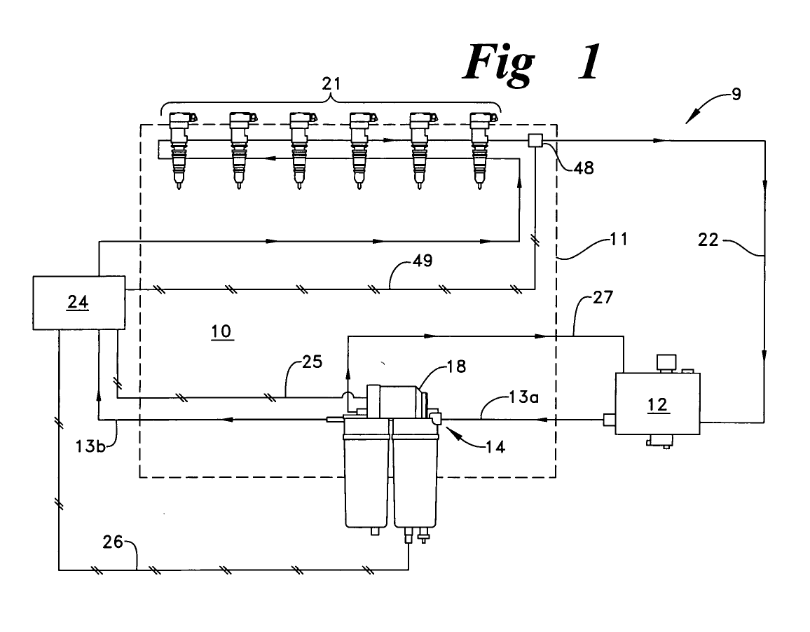

Referring to FIG. 1, there is shown a schematic representation of an engine and a fuel system according to the present invention. Although the present invention will be described for a dual fuel filter pump module 14, it should be appreciated that the present invention operates similarly for a multiple fuel filter pump module including any number of fuel filters. For instance, the present invention contemplates a triple fuel filter pump module that includes a primary fuel filter assembly upstream from the pump, and two secondary fuel filter assemblies downstream from the pump. The secondary fuel filters would be in a series configuration, meaning that the fuel passes through one fuel filter and then through the other fuel filter, for improved filtration performance. The triple fuel filter pump module may find application in larger engines or engines requiring high efficiency filtration in heavy duty/severe service applications.

The engine 10 comprises an engine housing 11 to which the fuel system 9 is attached. A fuel tank 12 is provided within the fuel system 9 and is in fluid communication with a dual fuel filter pump module 14 via an upstream portion 13a of a fuel supply line 13 and a regulator fuel line 27. The dual fuel filter pump module 14 is preferably attached to the engine housing 11 in a conventional manner. However, it should be appreciated that the present invention contemplates the dual fuel filter pump module 14 being attached to a body of a vehicle or work machine. A portion of the fuel flowing from the dual fuel filter pump module 14 is delivered to a downstream portion 13a of the fuel supply line 13, and a portion of the fuel is returned back to the fuel tank 12 via the regulator fuel line 27 for re-circulation through the fuel system 9. The fuel flowing through the downstream portion 13b of the fuel supply line 13 preferably passes over the electronic control module 24 in order to exchange heat with the electronic control module 24. The heat generated by the electronic control module 24 can be transferred to the fuel in order to warm the fuel and cool the electronic control module 24. After being warmed by the electronic control module 24, the fuel is delivered to at least one fuel injector 21 via the downstream portion 13b of the supply line 13. While the present invention is illustrated as including six fuel injectors 21, it should be appreciated that the present invention is applicable to an engine housing any desired number of fuel injectors. The fuel not injected into the engine 10 by the fuel injector 21 is returned to the fuel tank 12 via a return line 22.

A pressure sensor 48, preferably a secondary pressure sensor, is positioned within the return line 22, and is in electrical communication with the electronic control module 24 via a sensor communication line 49. The electronic control module 24 is in communication with the dual fuel filter pump module 14 via a first communication line 25 and a second communication line 26. Electric current is supplied to various electronically-controlled and/or electrically-powered components of the dual fuel filter pump module 14 via the communication lines 25 and 26. The present invention contemplates the dual fuel filter pump module 14 including various types of electronically-controlled and/or electrically-powered components, including, but not limited to, a fuel temperature sensor, a pressure sensor, a fuel pump, a water-in-fuel sensor, and a fuel heater. The pressure sensor could sense the pressure differential across the filters, and communicate such to the electronic control module 24. Further, the water-in-fuel sensor could sense when there is water in the fuel, and communicate such to the electronic control module 24. The electronic control module 24 could then determine whether the fuel filters required changing and/or whether the water required draining, and limit the engine power until the sensed condition is fixed. Although the present invention illustrates two communication lines 25 and 26, it should be appreciated that the dual fuel filter pump module 14 could be wired such that there is only one connection line between the dual fuel filter pump module 14 and the electronic control module 24.

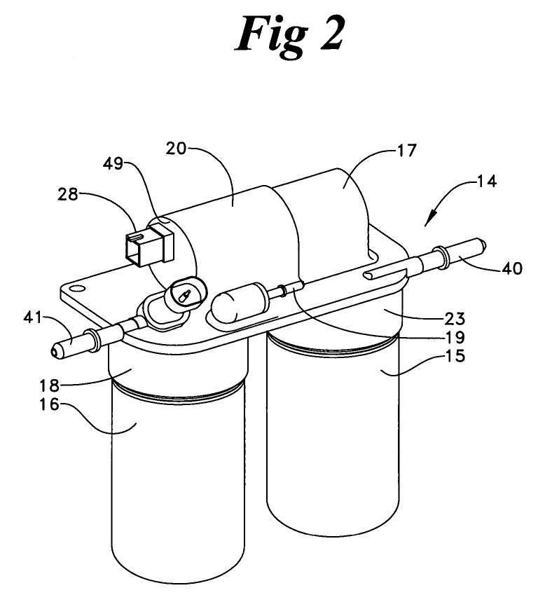

Referring to FIG. 2, there is shown a side view of the dual fuel filter pump module 14 of FIG. 1. The dual fuel filter pump module 14 includes a module housing 18. The module housing 18 includes a pump housing 20 and a dual fuel filter head portion 23 being integrally molded from a plastic material. It should be appreciated that any plastic material known in the art to be sufficiently strong to withstand the vibrations and heat produced by the engine 10 may be utilized. For instance, the module housing 18 could be molded from reinforced nylon. Further, it should be appreciated that the plastic material can be reinforced with a metal reinforcement, such as a steel reinforcement. The module housing 18 defines a housing fuel inlet passage 40 and a housing fuel outlet passage 41. The pump housing 20 defines a pump opening within which a fuel pump 17 is installed, preferably irreversibly. The fuel pump 17 includes an end cap 49 that mates to the pump housing 20 and becomes a portion of the pump housing 20. The fuel pump 17 is preferably electrically-powered, and, due to its position on the engine 10, the fuel pump 17 can prime fuel system components, including a possible secondary pump, that are positioned downstream from the pump 17.

The dual fuel filter pump module 14 also includes a pressure regulator 19. The pressure regulator 19 maintains the pressure of, and removes air from, the fuel being delivered from the dual fuel pump module 14. If the pressure regulator 19 is performing properly, fuel delivered to fuel system 9 downstream from the pressure regulator 19 has relatively small amounts of air, whereas the bulk of any air that enters the fuel supply is returned in a mixture with fuel via the regulator fuel line 27 back to tank 12. The electric fuel pump 17 preferably operates at a constant flow rate via a continuous electrical supply that is provided via an electrical connector 28. The relatively fixed flow rate of pump 17 is preferably sized to meet the maximum demands of fuel injectors 21 even when a substantial portion of the fuel is recirculated via the regulator fuel line 27. Although the fuel pump 17 is illustrated as a fixed delivery fuel pump, it should be appreciated that the present invention contemplates a variable delivery fuel pump that varies the flow of fuel to the downstream portion of the fuel system 9.

A first detachable fuel filter assembly 15 is preferably attached to the dual fuel filter head portion 23 of the module housing 18 upstream from the fuel pump 17, and a second detachable fuel filter assembly 16 is preferably attached to the dual fuel filter head portion 23 downstream from the fuel pump 17. The detachable fuel filter assemblies 15 and 16 could be attached to the dual fuel filter head portion 23 in any convention manner, including, but not limited to, threadibly mating fuel filter assembly 15 and 16 to the head portion 23. The first fuel filter assembly 15 acts to trap precipitates and other larger solids from the fuel flowing through the supply line 14, and to separate water from the fuel. The second fuel filter assembly 16 acts to trap finer particulates and other solids from the fuel. Preferably, the electrical socket 28 is included within the pump housing 20, specifically within the end cap 49. The first communication line 25 includes a connector that mates with the electrical socket 28 in order to electrically connect the electronic control module 24 to the electrically-powered fuel pump 17 and any other electrically powered or controlled components of the dual fuel filter pump module 14, including but not limited to a primary fuel pressure sensor, a fuel temperature sensor, a fuel filter heater, and a water-in-fuel sensor. It should be appreciated that although the present invention illustrates a second socket attached to the first detachable fuel filter assembly 15 which could serve as an electrical connection for the fuel filter heater and/or water-in-fuel sensor, the fuel filter heater and the water-in-fuel sensor could be connected to the electronic control module 24 via the electrical socket 28.

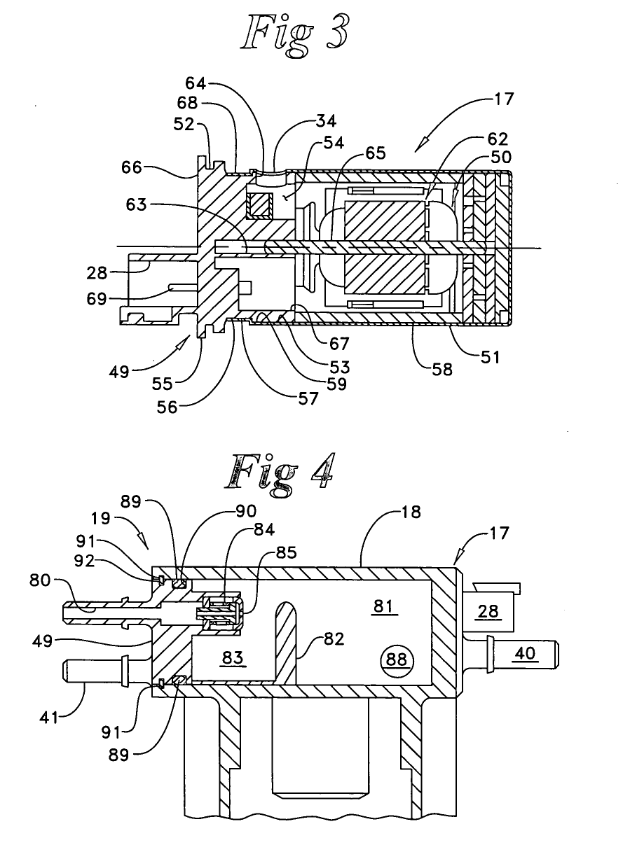

Referring to FIG. 3, there is shown a sectioned side diagrammatic view of the fuel pump 17 included within the dual fuel filter pump module 14 of FIG. 2. The fuel pump 17 includes a partial electric motor/pump assembly 50, a metallic can shaped housing 51, and the end cap 49. In order to make the pump 17 less serviceable, the end cap 49 preferably includes a snap ring groove 52 that mates with a snap ring to a receiving groove defined by pump housing 20 in a conventional manner. The can shaped housing 51 is preferably made from a suitable shaped metal material that can be deformed to provide a suitable and relatively irreversible attachment to the end cap 49. When mated as shown in FIG. 3, the can shaped housing 51 and the end cap 49 define an internal cavity 53 that includes a fluid passage 54 defined in part by a plastic molding 55, which makes up the bulk of the end cap 49. The can shaped housing 51 defines a pump inlet 33 (shown in FIG. 6) and a pump outlet 34 that both open to the internal cavity 53. Thus, when in operation, fuel is drawn into the pump inlet 33 and exits the fuel pump 17 via the pump outlet 34 under the action of the electric motor 62 and pump assembly 50.

The can shaped housing 51 includes a flared end 56 that facilitates the mating of the can shaped housing 51 with the end cap 49. The attachment is preferably completed by deforming a portion of the can shaped housing 51 into at least one retention recess 57 defined by plastic molding 55. The retention recess 57 is illustrated as including an annular groove, and the annular end portion 56 of the can shaped housing 51 is deformed in a conventional manner, such as by use of a roller, into the annular retention recess 57. This attachment strategy renders the fuel pump 17 relatively unserviceable by making it difficult to impossible to disengage the can shaped housing 51 from the end cap 49 without damaging one or both components.

Referring still to FIG. 3, the plastic molding 55 includes the electrical socket 28 that is electrically connected to a pair of motor brushes (not shown) via a suitable conductor. When the end cap 49 is mated to the can shaped housing 51, a cylindrical portion 58 of the end cap 49 comes in contact with an inner surface 59 of the can shaped housing 51. The end cap 49 includes at least one motor alignment guide surface (not shown) that mates into a recess in partial electric motor/pump assembly 50 in order to insure that brushes are appropriately located on the armature of the electric motor 62. In addition, the motor alignment guide helps to insure that a flow passage 64 defined by plastic molding 55 aligns with the pump outlet 34 so that fluid passage 54 can communication with the pump outlet 34. In addition, plastic molding 55 includes a shaft support recess 63 that receives a portion of rotatable shaft 65 that also acts as a journal bearing for the same. Recess 63 could house a brass or other material journal bearing for increased run dry protection.

The plastic molding 55 is shaped to include an external face 66 separated from an internal face 67 by a circumferential side surface 68. The side surface 68 is preferably shaped to include the cylindrical portion 58 that closely matches the inside diameter of the can shaped housing 51 and the annular retention recess 57 into which the flared end 56 of the housing 51 is deformed in order to secure the end cap 49 to the can shaped housing 51. The external face 66 is preferably molded to include any suitable electrical connector socket 28, which can be any type known in the art. The internal face 67 is preferably formed to include the shaft support recess 63, the pair of brush placement holders, and a pair of inductor holders (not shown). Preferably, a conductor and motor brush assembly is attached to the plastic molding 55 in a suitable manner, such as by the use of shunts, to produce an assembled end cap 49. Conductors are preferably positioned so that a pin portion 69 is exposed through the external face 66 in the socket 28, and brushes are supported by brush holders. Preferably, conductors include a conductor pin that is attached to a wire, which is wound around an inductor core and electrically connected to an electric motor brush by a brush support. The brush support and the inductor core are received in, and supported by, brush placement holders and inductor holders, respectively. Thus, end cap 49 carries at least one essential electric component necessary to complete the electric motor 62. In addition, the electrical connection made to the socket 28 is done without having to connect wire between a separate motor terminal and a socket, and thus the integrated design eliminates the need for terminals on the electric motor 62.

Referring to FIG. 4, there is shown a sectioned side view of a pressure regulator 19 of the dual fuel filter pump module 14 of FIG. 2. After fuel passes from fuel pump 17, the fuel and any air mixed with the same, is preferably passed to the pressure regulator 19 where the fuel air mixture is divided between two separate passages. The pressure regulator 19 operates to concentrate the bulk of the air into a bypass vent passage 80 that is returned to fuel tank 12 via the regulator fuel line 27. The remaining portion of the fuel, that contains relatively low concentrations of air, is passed to the downstream portion 13b of the supply line 13 at a relatively steady pressure.

The pressure regulator 19 occupies a portion of the module housing 18, and includes an inlet cavity 81 separated from an outlet cavity 83 by a baffle 82. Preferably, when in operation in fuel system 9, the module housing 18 has an orientation as shown in FIG. 4 such that a regulator inlet passage 88 and the housing outlet passage 41 open to their respective inlet cavity 81 and outlet cavity 83 at locations elevationally below the top of baffle 82. Vent passage 80 is preferably located elevationally above the housing outlet passage 41 and positioned adjacent the top of baffle 82. A pressure regulating valve 84 is preferably positioned between vent passage 80 and outlet cavity 83. However, pressure regulating valve 84 could be positioned at any suitable location in the regulator fuel line 27. Because the fuel transfer pump 17 operates at a relatively constant flow rate, pressure regulating valve 84 is preferably a spring biased check valve that opens when pressure in outlet cavity 83 exceeds a predetermined pressure. For instance, during low fuel demands, such as when the engine 10 is operating at idle, the bulk of the fuel moved by the fuel pump 17 pushes open fuel pressure regulating valve 84 to route the excess fuel back to tank 12 via the vent passage 80. A bleed orifice 85 can be incorporated into pressure regulation valve 84 as shown, or can be simply a separate passage of a predetermined flow area connecting vent passage 80 to outlet cavity 83. The flow area of the bleed orifice 85 is preferably sized to be as large as possible in order to speed priming without undermining the ability of the pressure regulator 19 to meet the maximum demands of fuel injectors 21 via the flow through the housing outlet passage 41.

The positioning, shape and height of baffle 82 influences the effectiveness of the pressure regulator 19. For instance, the height of the baffle 82 should preferably be such that the flow area over the baffle 82 is substantially larger, maybe on the order of 50% larger, than the combined flow area of bleed orifice 85 and the housing outlet passage 41, and also greater than the flow area of regulator inlet passage 88 in order to avoid creation of a flow restriction to the flow over the baffle 82. In addition, the positioning of baffle 82 should preferably be such that inlet cavity 81 is sufficiently large that fuel speed slows when entering inlet cavity 81 before flowing over baffle 82. As the fuel and air mixture flows over baffle 82, the air tends to rise toward the higher areas via a buoyancy effect in order to be captured in bleed orifice 85 and routed back to fuel tank 12. Because of the difficulty in molding baffle 82 directly into module housing 18, it is preferably attached and molded as a portion of the end cap 49 that includes vent passage 80 and outlet passage 41. The pressure regulation valve 84 is then attached to end cap 49 in a conventional manner. The end cap 49 is also molded to include an O-ring groove 90, a snap ring groove 92 and small flexible sealing flanges (not shown) that partially surround baffle 82. Sealing flanges tend to insure that fuel flows over baffle 82 rather than around it. In addition, the biased direction of the sealing flanges insures that pressure in inlet cavity 81 urges the sealing flanges into contact with the interior wall of the inlet cavity 81 to prevent fuel from flowing around the baffle 82. When the end cap 49 is mated into the remaining portion of the module housing 18, an O-ring 89 is positioned in the O-ring groove 90 and serves to prevent leakage of fuel from the pressure regulator 19 to the outside of the module housing 18. In addition, a snap ring 91 is positioned in the snap ring groove 92 to secure the end cap 49 to the remaining portion of the housing 18, and preferably render the same irreversibly attached and hence nonservicable.

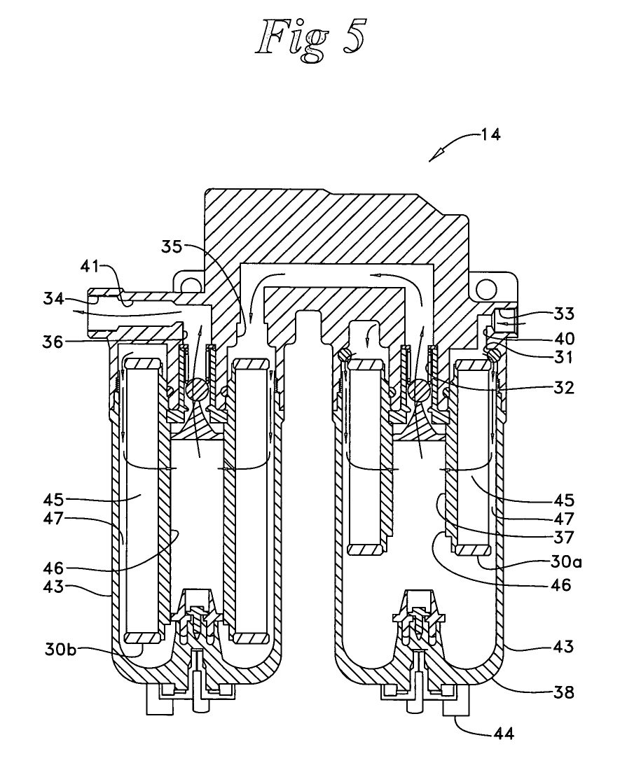

Referring to FIG. 5, there is shown a sectioned side view of the dual fuel filter pump module 14 of FIG. 2. Each detachable fuel filter assembly 15 and 16 includes a fuel filter assembly housing 43. The first detachable fuel filter assembly 15 includes a first fuel filter 30a, and the second detachable fuel filter assembly 16 includes a second fuel filter 30b. Each fuel filter 30a and 30b includes a cylindrical core defining a center passage 46, and a filter element 45 comprised of a medium that is suitable for separating contaminants and defining outer peripheral passages 47. The first fuel filter 30a also acts as a water separator 37. Thus, as the fuel flows through the first fuel filter 30a, in addition to particulates being separated from the fuel, water, due to its specific gravity, will separate from the fuel and collect in a water collection bowl 38 which is the bottom cupped-shaped area of the first fuel filter assembly housing 43. Although the first fuel filter assembly 15 preferably includes a water drain valve 44 to drain the collected water from the water collection bowl 38, it should be appreciated that other means of removing the water from the water collection bowl 38 could be used. For instance, a removable water collection bowl could be attached at the lowest point of the fuel filter assembly housing 43 for removal of the collected water. Moreover, the first fuel filter assembly 15 could include any type of water-in-fuel sensor known in the art, including but not limited to, an electrical water-in-fuel sensor or a water level indicator viewed through an opaque water collection bowl. Those skill in the art will appreciate that the first fuel filter assembly 15 could also include a fuel heater of various types, including but not limited to a coil heater positioned below the fuel filter 30a and/or a thin film heater attached to an inner surface 59 of the fuel filter assembly housing 43.

The arrows in FIG. 5 illustrate the flow of fuel through the dual fuel filter pump module 14. Those skilled in the art will appreciate that the first fuel filter 30a is considered a suction fuel filter being that fuel filter 30a is upstream from the fuel pump 17. Further, those skilled in the art will appreciate that the second fuel filter 30b is considered a pressure fuel filter being that the fuel filter 30b is downstream from the fuel pump 17. The first detachable fuel filter assembly 15 includes a first inlet 31 and a first outlet 32. The first inlet 31 is in fluid communication with the housing inlet passage 40 defined by the module housing 18, and the first outlet 32 is in fluid communication with the pump inlet 33. The second detachable fuel filter assembly 16 includes a second inlet 35 and second outlet 36. The second inlet 35 is in fluid communication with the pump outlet 34, and the second outlet 36 is in fluid communication with the housing outlet passage 41 defined by the module housing 18. Prior to flowing out the housing outlet passage 41, the fuel will flow through the regulator inlet 88 and the cavities 81 and 83 of the pressure regulator 19 in order for the pressure regulator 19 to remove the air from and regulate the pressure of the exiting fuel.

### INDUSTRIAL APPLICABILITY

Referring to FIGS. 1-5, the construction of the dual fuel filter pump module 14 will be discussed, although the present invention contemplates that construction of the triple fuel filter pump module would be similar. It should be appreciated that the dual fuel filter pump module 14 can be constructed for and utilized in various types of over the road and off road vehicles and work machines. The module housing 18 is formed to include the pump housing 20 and the fuel filter head portion 23. The module housing 18 is preferably molded from the plastic material in a conventional manner. Although other materials, such as a metallic casting, could be used to form the module housing 18, a plastic material, such as reinforced nylon, is preferred because it is less expensive and is capable of withstanding the vibrations and heat produced by the operation of the vehicle or work machine. Plastic is also preferred by its ability to insulate electrical components embedded in the plastic. For instance, the electrical socket 28 could include connectors for each of the electrically-powered and/or controlled components within the dual fuel filter pump module 24, such as a fuel heater, a temperature sensor, a pressure sensor, and the fuel pump 17.

Referring now to FIG. 3, those skilled in the art should appreciate that although the fuel pump 17 is illustrated as a fixed delivery pump, various types of fuel pumps, such as a variable displacement pump, could be utilized. The pump 17 preferably utilizes a partial electric motor/pump assembly 50 of a type manufactured by Airtex Products of Fairfield, Ill. This subassembly 50 is then positioned within the can shaped housing 51 as shown in FIG. 3. The can-shaped housing 51 including the motor/pump assembly 50 is then positioned within the module housing 18, specifically within the pump housing 20. Next, the plastic molding 55 of the end cap 49 is formed and electrical conductors are extended between the external face 66 and electric motor brushes that are attached to the end cap 49. The electrical socket 28 is preferably integrated into the plastic molding 55. Next, the electric motor 62 is completed by mating the end cap 49 to the can shaped housing 51. In order to insure that complete mating as shown in FIG. 3, it is preferably necessary to mate alignment guide surface with an appropriate mating surface on the partial electric motor/pump assembly 50. This feature insures that electric brushes will be properly located in the complete assembly and that the flow passage 64 will align with the pump outlet 34. In addition, the mating of the end cap 49 with the can-shaped housing 51 includes having the shaft support recess 63 receive an end portion of the rotatable shaft 65. This preferably is accomplished by making the centerline of the shaft support recess 63 concentric with the centerline of the cylindrical portion 58 that comes in contact with the inner surface 59 of can shaped housing 51. The end cap 49 is attached to the can shaped housing 51 preferably by deforming the annular end portion 56 into the annular retention recess 57 formed on this side surface 68 of the plastic molding 55.

When the module housing 18 including the fuel pump 17 is positioned with the fuel system 9, the supply line 13 must be connected and secured to the housing inlet passage 40 and the housing outlet passage 41. Further, the pressure regulator 19 must be connected and secured to the regulator return line 27. Because the module housing 18 is comprised of a plastic material, steel inserts could be injection molded into the inlet 40 and the outlet 41 in order to withstand the torque caused by the connection to the supply line 13. However, in order to eliminate costly steel inserts, the present invention contemplates outlet fittings being positioned within at least the inlet and outlet 40 and 41 to withstand the torque. The outlet fittings include an adapter, a pin, and o-rings. The adapter can spin radially while being restrained axially by the pin. The o-rings will create a seal to prevent leaking. There can be variations of the fitting for different types of connections, such as a quick disconnect.

Referring to FIG. 5, after the fuel pump 17 is positioned within the module housing 18, the first detachable fuel filter assembly 15 and the second detachable fuel filter assembly 16 are attached to the dual fuel filter head portion 23 of the module housing 17. The fuel filter assemblies 15 and 16 can be attached to the dual fuel filter had portion 23 in any conventional manner, such as mating each fuel filter assembly housing 43 to a corresponding threaded portion of the fuel filter head portion 23. The fuel filter assemblies 15 and 16 are attached such that the first outlet 32 of the first detachable fuel filter 15 is in fluid communication with the pump inlet 33, and the pump outlet 34 is in fluid communication with the second inlet 35 of the second detachable fuel filter assembly 16. Preferably, the dual fuel filter pump module 14 will be attached to the engine 10 by mounting the module housing 18 to the engine housing 11 in a conventional manner. However, it should be appreciated that the dual fuel filter pump module 14 could be mounted to the chassis of the vehicle or work machine. Further, it should be appreciated that the dual fuel filter pump module 14 can be mounted on various types and sizes of engines.

Referring to FIGS. 1-5, the operation of the dual fuel filter pump module 14 will be discussed. Upon activation of the vehicle or work machine, the fuel pump 17 will begin drawing fuel from the fuel tank 12 to the first detachable fuel filter 15 via the upstream portion 13a of the supply line 13. The fuel will flow into the housing inlet passage 40 and through the first inlet 31 of the first detachable fuel filter assembly 15. As the fuel then flows through the outer peripheral passages 47 of the fuel filter 30a, particulates are separated from the fuel. The first fuel filter 30a, also referred to as a primary filter, will separate the relatively larger solids and particulates from the fuel. For instance, the first fuel filter 30a of the present invention will remove particulates and solids as small as 10 microns from the fuel. Further, as the fuel flows through the fuel filter 30a, the water separator 37 separates the water from the fuel. Due to its specific gravity, the water falls to the water collection bowl 38 below the fuel filter 30a. Periodically, the water can be drained from the first detachable fuel filter assembly 15 via the water drain valve 44. It should be appreciated that the present invention contemplates a water-in-fuel sensor included within the first fuel filter assembly 15 that can alert the operator when water needs to be drained from the fuel filter assembly 15. If the water-in-fuel sensor is electric, the water-in-fuel sensor could be in communication with the electronic control module 24 or a power source via the first or second communication line 25 and 26.

After the fuel flows across the filter element 45, the fuel will be drawn by the fuel pump 17 up through the center passage 46 and out the first outlet 32. Those skilled in the art will appreciate that because paraffins that can clog the fuel filters 30a and 30b form in diesel fuel in cold weather, a fuel heater might be positioned within the first detachable fuel filter assembly 15. As the fuels flows through the fuel filter 30a, the fuel heater, such as a thin film heater attached to the inner surface of the assembly housing 43 or coils positioned below the fuel filter 30a, will warm the fuel. The present invention contemplates the fuel heater being in communication with the electronic control module 24 or a power source via either the first or second communication line 25 or 26. The heated fuel will flow from the fuel filter 30a to the fuel pump 17 via the pump inlet 33. The fuel pump 17 will pressurize the fuel for circulation through the fuel system 9. The fuel will travel to the second detachable fuel filter assembly 16 via the second inlet 35. The fuel will then travel along the outer peripheral passages 47, across the filter element 45 and up the center passage 46 just as it did in the first detachable fuel filter assembly 15. However, the second fuel filter 30b, also referred to as a secondary filter, performs more intense filtration of the fuel than the first fuel filter 30a. In the present invention, as the fuel passes through the second fuel filter 30b, the fuel filter 30b will separate particulates and solids as small as 2 microns from the fuel. Further, the fuel is being pushed through the second fuel filter 30b rather than be drawn through by the fuel pump 17, and the second fuel filter assembly 16 may not include a fuel heater. Because the first detachable fuel filter assembly 15, the fuel pump 17 and the second detachable fuel filter assembly 16 are included in one module 14, the heated fuel must only travel a short distance from the first fuel filter assembly 15 to the second fuel filter assembly 16. Therefore, the fuel loses less heat prior to flowing through the second filter 30b, and thereby reducing the risk of formation of paraffins that clog the second fuel filter 30b.

After the fuel has been intensely filtered by the second fuel filer 30b, the fuel flows from the second outlet 36 to the inlet cavity 51 of the pressure regulator 19 via the regulator inlet 88 shown in FIG. 4. The fuel then flows over the baffle 82 into the outlet cavity 83. Because the flow pattern developed by the baffle 82 and due to the buoyancy forces produced by gravity, the air laden fuel is directed into the bleed hole 85 for recirculation back to the fuel tank 12 via the vent passage 80 and the regulator fuel line 27. The portion of the fuel with little or no air is directed into the housing outlet passage 41 and directed to the fuel injectors 21 via the downstream portion 13b of the supply line 13. When fuel demand is low, such as at low speed and low conditions, the excess fuel produced by the electric transfer pump 17 causes a pressure rise in the outlet cavity 83 that pushes pressure regulating valve 84 to an open position to simply route the excess fuel back to the tank 12.

As the fuel in the supply line 13 passes by the electronic control module 24, it will absorb the heat from the electronic control module 24, resulting in the cooling of the electronic control module 24 and the heating of the fuel. The fuel not injected into the engine 10 via the fuel injectors 21 will be returned via the return line 22 to the fuel tank 12 for re-circulation through the fuel system 9. The pressure sensor 48 positioned within the return line 22 will sense the pressure of the fuel and communicate the sensed pressure back to the electronic control module 24 via the sensor communication line 49. The electronic control module 24 can determined whether the pressure within the return line 22 is the desired pressure.

Overall, the present invention is advantageous because it permits intense filtering of the fuel by providing two fuel filters without consuming a relatively large amount of space within the vehicle body. The compact dual fuel filter pump module 17 including the first detachable fuel filter assembly 15, the second detachable fuel filter assembly 16, and the fuel pump 17 consumes less space than if the three components were unattached. Due to the less space being consumed, there is room for the dual fuel pump module 14 to be attached to the engine housing 11, rather than having at least one fuel filter assembly 15 or 16 being attached to the vehicle body. Thus, the engine 10 can be sold and installed with the fuel filters 15 and 16 already attached, rather than the fuel filters having to be purchased separately and/or attached separately to the vehicle body. This reduces the time and expense of installation. On the other hand, if the purchaser would like, the dual fuel filter pump module 14 could be purchased separately from an engine so that the purchaser can attach the module 14 to various types of engines with various applications. In addition, due to the reduced space consumed by the dual fuel filter pump module 14, the dual fuel filter pump module 14 can be positioned such that the fuel pump 17 can also act as a primer pump for the fuel system 9. For instance, when the vehicle is brand new or when it runs completely out of fuel, the fuel pump 17 can create sufficient suction to push vapor out of the pump and draw the fuel from of the fuel tank 12 and circulate the fuel through the fuel system 9.

Moreover, because the fuel filters 15 and 16 and the fuel pump 17 are compactly attached to one another, there is no need for fuel lines to run between the three components. Thus, there are less fuel lines within the fuel system 9 resulting in a reduced potential for leaks and a reduced cost of manufacturing. Similarly, because the fuel filters 15 and 16 and the fuel pump 17 are compactly attached to one another, the number of electrical connections between the filters 15 and 16 and the fuel pump 17 and the electronic control module 24 can be reduced. For instance, there could be one electrical socket 28 to which one communication line 25 is attached in order to provide electrical communication between the electronic control module 24 and the fuel heater, the water-in-fuel sensor, the electrically-powered pump 17, and all the sensors. This too would reduce manufacturing costs. Manufacturing costs are further reduced by the use of the plastic material rather than a metallic casting.

The fact that the fuel filters 15 and 16 and the fuel pump 17 are compactly attached to one another is also advantageous because the fuel does not have a relatively large distance to flow from the first fuel filter assembly 15 to the second fuel filter assembly 16. Thus, the heat that is transferred to the fuel from the fuel heater in the first fuel filter assembly 15 is not lost by the time the fuel passes through the second fuel filter assembly 16. Thus, the risk of formation of paraffins clogging the second fuel filter 30b is reduced.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. An engine comprising:
an engine housing;
a multiple fuel filter pump module including a module housing attached to the engine housing; and more than one detachable fuel filter assemblies, being attached to the module housing; and
a fuel pump being positioned within the module housing.

2. The engine of claim 1 wherein the module housing includes a pump housing and a multiple fuel filter head portion; and
the pump housing and multiple fuel filter head portion being integrally molded from a plastic material.

3. The engine of claim 2 wherein the module housing includes at least a portion of an end cap;
the portion of the end cap and an electrical socket being integrally molded from a plastic material.

4. The engine of claim 1 wherein at least one of the detachable fuel filter assemblies include a water separator and a water drain valve.

5. The engine of claim 1 wherein the more than one detachable fuel filter assemblies include a first detachable fuel filter assembly and a second detachable fuel filter assembly; and
the first detachable fuel filter assembly includes an outlet fluidly connected to an inlet of the fuel pump; and the second detachable fuel filter assembly includes an inlet fluidly connected to an outlet of the fuel pump.

6. The engine of claim 1 wherein the fuel pump being an electrically-powered fuel pump.

7. The engine of claim 1 wherein the module housing includes at least a portion of a pressure regulator.

8. The engine of claim 3 wherein the more than one detachable fuel filter assemblies include a first detachable fuel filter assembly and a second detachable fuel filter assembly; at least one of the first detachable fuel filter assembly and the second detachable fuel filter assembly includes a water separator and a water drain valve;
the first detachable fuel filter assembly includes an outlet fluidly connected to an inlet of the fuel pump; and the second detachable fuel filter assembly includes an inlet fluidly connected to an outlet of the fuel pump;
the fuel pump being an electrically-powered fuel pump; and
the module housing includes at least a portion of a pressure regulator.

9. A multiple fuel filter pump module comprising:
a module housing;
more than one detachable fuel filter assemblies being attached to the module housing; and
a fuel pump being positioned within the module housing.

10. The multiple fuel filter pump module of claim 9 wherein the module housing includes a pump housing and a multiple fuel filter head portion; and
the pump housing and multiple fuel filter head portion being integrally molded from a plastic material.

11. The multiple fuel filter pump module of claim 10 wherein the module housing includes a least a portion of an end cap; and
the portion of the end cap and an electrical socket being integrally molded from a plastic material.

12. The multiple fuel filter pump module of claim 9 wherein at least one of the detachable fuel filter assemblies include a water separator and a water drain valve.

13. The multiple fuel filter pump module of claim 9 wherein the more than one detachable fuel filter assemblies includes a first detachable fuel filter assembly and a second detachable fuel filter assembly; and
the first detachable fuel filter assembly includes an inlet fluidly connected to an inlet of the fuel pump; and the second detachable fuel filter assembly includes an inlet fluidly connected to an outlet of the fuel pump.

14. The multiple fuel filter pump module of claim 9 wherein the pump being an electrically-powered fuel pump.

15. The multiple fuel filter pump module of claim 11 wherein at least one of the first detachable fuel filter assembly and the second detachable fuel filter assembly includes a water separator and a water drain valve;
the first detachable fuel filter assembly includes an inlet fluidly connected to an inlet of the fuel pump; and the second detachable fuel filter assembly includes an inlet fluidly connected to an outlet of the fuel pump; and
the fuel pump being an electrically-powered fuel pump.

16. A method of constructing a multiple fuel filter pump module, comprising the steps of:
forming a module housing to include a pump housing and a dual fuel filter head portion;
positioning a fuel pump within the module housing; and
attaching more than one detachable fuel filter assemblies to the module housing.

17. The method of claim 16 wherein the step of forming includes a step of molding the module housing from a plastic material.

18. The method of claim 16 wherein the step of positioning includes a step of attaching an end cap of the fuel pump to the module housing.

19. The method of claim 16 wherein the step of attaching includes a step of fluidly connecting an outlet of a first detachable fuel filter to an inlet of the fuel pump, and fluidly connecting an inlet of a second detachable fuel filter to an outlet of the fuel pump.

20. The method of claim 16 including a step of attaching the module housing to an engine housing.
